(19) United States
(12) Patent Application Publication
(10) Pub. No.: US 2017/0270817 A1
(43) Pub. Date: Sep. 21, 2017

(54) Plant Growth Advisor Device and System

(71) Applicants: Alex K. Kasravi, West Bloomfield, MI (US); Hunter K. Kasravi, West Bloomfield, MI (US); Diane S. Kasravi, West Bloomfield, MI (US); Kas Kasravi, West Bloomfield, MI (US)

(72) Inventors: Alex K. Kasravi, West Bloomfield, MI (US); Hunter K. Kasravi, West Bloomfield, MI (US); Diane S. Kasravi, West Bloomfield, MI (US); Kas Kasravi, West Bloomfield, MI (US)

(21) Appl. No.: 15/462,782

(22) Filed: Mar. 17, 2017

Related U.S. Application Data
(60) Provisional application No. 62/309,455, filed on Mar. 17, 2016.

(51) Int. Cl. G09B 19/00; G06N 5/04; A01G 9/00; A01G 7/00; G09B 5/00

(52) U.S. Cl. CPC G09B 19/00; A01G 7/00; G09B 5/00; A01G 9/00; G06N 5/045

(57) ABSTRACT

The present invention relates to both a device and a system for monitoring plants and providing advice to a plant grower for optimizing indoor and outdoor plant growth. The device is packaged within a natural housing to promote a natural and pleasing appearance blending with the plant environment. With respect to the device, the core components are a probe comprising the plurality of environmental sensors, a microcontroller, a communication device, and a power source. With respect to the system, it is best characterized as a connected architecture capable of remotely exchanging information among the probe, a mobile device, a mobile app, a plant profile, a decision engine, a network, a remote computer, and a plant profile database. This system captures the target plant's current environmental conditions from the probe in real-time, compares the environmental conditions with the optimal parameters in the plant profile, and provides timely plant growth advice, where the latter is accomplished via a local alert or remotely via a mobile device.

### PRIORITY STATUS

This application claims the benefit of U.S. Provisional Application No. 62/309455, filed Mar. 17, 2016. The content of U.S. Provisional Application 62/309455 is incorporated herein by reference for all purposes.

### BACKGROUND OF THE INVENTION

1 Field of the Invention

The present invention relates generally to plant growth and, more specifically, to using technology to provide plant growth monitoring and advice.

2. Background

Currently there are a number of solutions on the market that provide advice for plant growth. Some of these solutions attempt to alert the plant grower if the environmental conditions are adversely affecting the growth of a plant, but these solutions fail to meet the needs of the industry because they lack user simplicity, and create an unsightly appearance that detracts from the natural beauty of plants. The latter can discourage plant growers from using such solutions.

It would be desirable to have a solution that provides real-time plant growth advice that is simple to use and does not visually impair the natural appearance of plants with the presence of artificial devices and gadgets. Furthermore, it would also be desirable to have a solution that requires less maintenance. Still further, it would be desirable to have a solution that remotely provides plant growth advice to the plant grower.

Plant growers have been growing plants for thousands of years, and technologies have been available for decades to help them with growing plants. However, there is an unfulfilled need in the industry for a solution that delivers real-time plant growth advice in a simple fashion without interfering with the natural beauty of plants.

### SUMMARY OF THE INVENTION

The present invention advantageously fills the aforementioned deficiencies by providing Plant Growth Advisor Device and System which provides real-time plant growth monitoring and advice to plant growers.

The present invention is a solution consisting of a probe with environmental sensors positioned close to a plant, and a back-end system consisting of a connected architecture supported by a remote computer, at least one plant profile database, a network, a mobile device, a mobile app, and a decision engine.

The probe is positioned inside a natural housing with a natural appearance. Natural appearance is any combination of shapes/colors/textures found in nature, such as branches, logs, leaves, flowers, rocks, small animals and so forth. A natural housing is a defined as an artifact that has the appearance of a naturally occurring object. The natural appearance of the natural housing allows the technological elements of the probe to be hidden, thus not detracting from the natural beauty of plants; the latter utility being highly desired by plant growers. Further, the probe includes a set of sensors for detecting air and soil environmental factors, such as ambient temperature, brightness, humidity, soil moisture, and soil temperature. For simplicity of use, the environmental factors are limited to the minimum set of factors that affect plant growth and can be easily controlled by the plant grower. The probe also includes a microcontroller, a communication device, and powered by a power source.

With respect to the system, it includes a connected architecture including a remote computer, at least one plant profile database of optimal plant information and growth characteristics for a plurality of plants, a mobile device, a mobile app, and a decision engine. The remote computer supports communications among the devices, performs authentication, manages security, and registers and assigns probes to users and mobile apps. The mobile app provides the plant grower with real-time information about a plant's environmental conditions, along with advice to optimize plant growth. The advice is based on a comparison of the current environmental conditions in the vicinity of the plant and the optimal growth conditions for the plant as defined in the database(s), and may include suggestions such as increasing the ambient brightness or adding water.

The present invention may also have one or more additional sensors to detect other environmental conditions, such as presence of fertilizers, soil temperature, wind, and soil pH. Further, the probe has a ground stake and flange to secure and stabilize it in the soil close to the plant(s) it monitors. Furthermore, the probe in the present invention may have a unique designation that is registered with the mobile app. The mobile app may monitor multiple probes, and a probe may monitor and provide advice for a plurality of plants in its vicinity. Several options for the power source are available including a battery, a solar battery charger, and direct power for a household outlet. Optionally, the database provide additional plant growth advice such as row width, spacing, fertilizer type, the optimal planting dates, and a mix of plants that grow well within the same vicinity. The information provided by the databases are optionally customized by the plant grower in the mobile app to reflect personal knowledge and preferences. The mobile app optionally stores data over time and provides statistical information about the plants being monitored. The probe is water tight. The probe provides advice via a display screen or audio-visual alerts locally or via a mobile device such as a smartphone.

The present invention is unique when compared with other known solutions in that it provides a natural appearance that blends into the plant environment and thus hides the underlying technologies from view. This natural appearance leads to a greater acceptance and utility by plant growers. Further, the present invention places several environmental sensors higher than other solutions, thus obtaining more accurate readings. Furthermore, the present invention provides a flange that adds to the stability of the probe when in use. Still further, the present invention provides an optional solar battery charger for recharging the probe's built-in batteries.

The present invention is unique due to the presence of: (1) a natural appearance of the probe that helps it blend in with the plant; (2) several of the sensors are placed above the soil line for more accurate readings; (3) a flange at the soil line that promotes the stability of the probe when in use; (4) optional solar battery charger for recharging the probe's built-in batteries; (5) integration with a mobile device; (6) a large database of plant profiles; and, (6) a decision engine for providing optimum advice.

Among other things, it is an object of the present invention to provide a too plant growth advisor device and system that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete, and will fully convey the full scope of the invention to those skilled in the art.

### BRIEF DESCRIPTION OF THE DRAWINGS

FIGS. 1a and 1b show the plant growth advisor apparatus

FIG. 2 shows the natural housing

FIG. 3 shows the probe and the natural housing in a plant pot

FIG. 4 shows the plant growth advisor system

FIG. 5 shows the plant growth advisor process

### DETAILED DESCRIPTION OF THE INVENTION

The present invention is directed to plant growth and, more specifically, to using technology to provide plant growth monitoring and advice.

In its most complete version, the present invention provides a device and a system to help plant growers more effectively grow indoor or outdoor plants. A plant grower is any individual interested in growing plants, and more particularly, a non-professional horticulturist who could benefit from optimal plant growing advice.

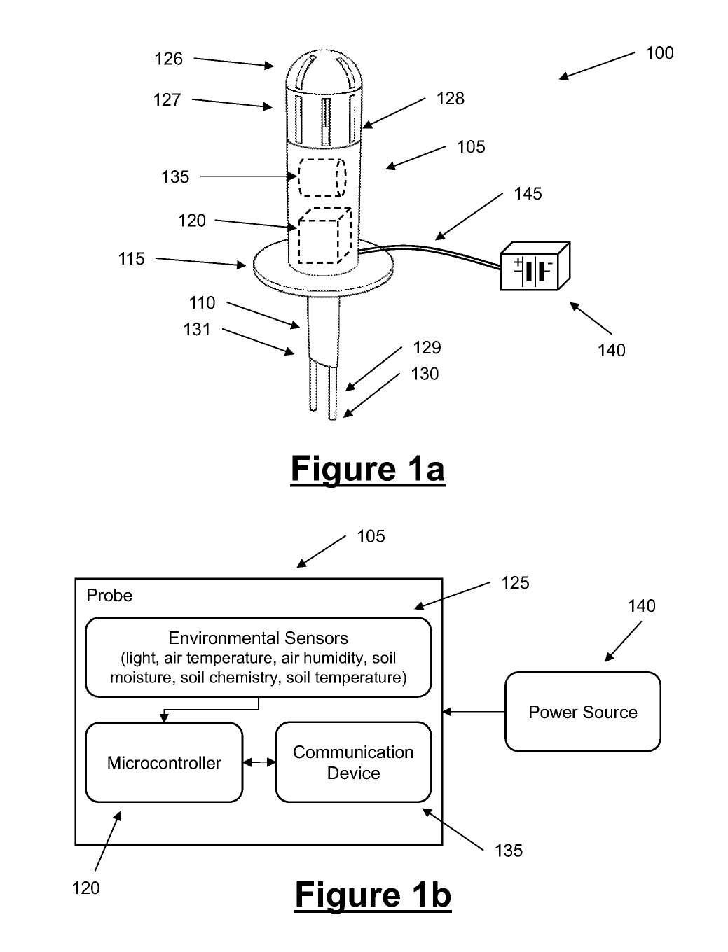

With respect to the device, the present invention comprises a probe that houses a plurality of environmental sensors, a microcontroller, and a communication device. With reference to FIGS. 1a and 1b, the plant growth advisor apparatus 100 has a probe 105, which has a ground stake 110, and a flange 115. The ground stake 110 is positioned at the bottom of the probe 105, and the flange 115 is located at the soil line. Together, the stake 110 and the flange 115 provide stability when the probe 105 is inserted into soil or a plant pot.

The probe 105 has a plurality of environmental sensors 125, including a light sensor 126 preferably pointed in an upward fashion, an air temperature sensor 127, an air humidity sensor 128, a soil moisture sensor 129, a soil chemistry sensor 130, and a soil temperature sensor 131. Collectively, these sensors capture the environmental factors in the vicinity of a plant.

The probe 105 has a microcontroller 120 for capturing and processing the sensor data, optionally running sensor analysis algorithms, and interacting with a communication device 135. The communication device 135 provides for two-way communication and data exchange with other devices, such as a mobile device or a smartphone. The communication device 135 is preferably wireless, and communicates via protocols such as Bluetooth or User Datagram Protocol (UDP).

The probe 105 and the said components are electrically powered by a power source 140. The power source 140 is preferably a combination of a battery and a solar battery charger for uninterrupted power supply. Another alternative for the power source 140 is the standard household electricity and an appropriate power adapter.

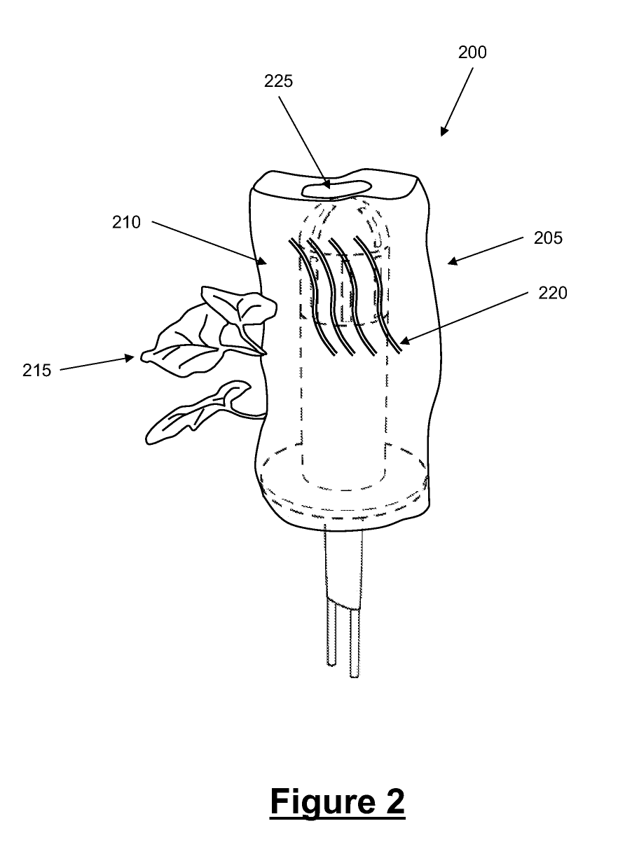

In the preferred embodiment of the present invention, the probe 105 is placed and secured within a natural housing that has a natural appearance. A natural appearance is defined as any combination of shapes/colors/textures found in nature, such as branches, logs, leaves, flowers, rocks, small animals and so forth, which would visually blend in with a plant and its surroundings. With reference to FIG. 2, natural housing 200 depicts an example of such natural housing. In this illustrated example, natural housing 200 consists of a log 205, with color and texture 210 of the log 205, and leaves 215. In other embodiments, the log 205 are replaced with other naturally occurring shapes such as flowers, small animals, a rock and/or similar objects. The natural housing 200 is fit snugly over the probe 105 and hides the technological appearance of the probe 105. The natural housing 200 provides adequate access for the sensors in probe 105 to obtain the necessary information from the environment. For example, a slit 220 provides air flow to air temperature sensor 127 and air humidity sensor 128. Also, a window 225 provides the light sensor 126 with access to ambient light. Not shown in the figures is an optional display or audio-visual alert to notify the plant grower when an action needs to be taken.

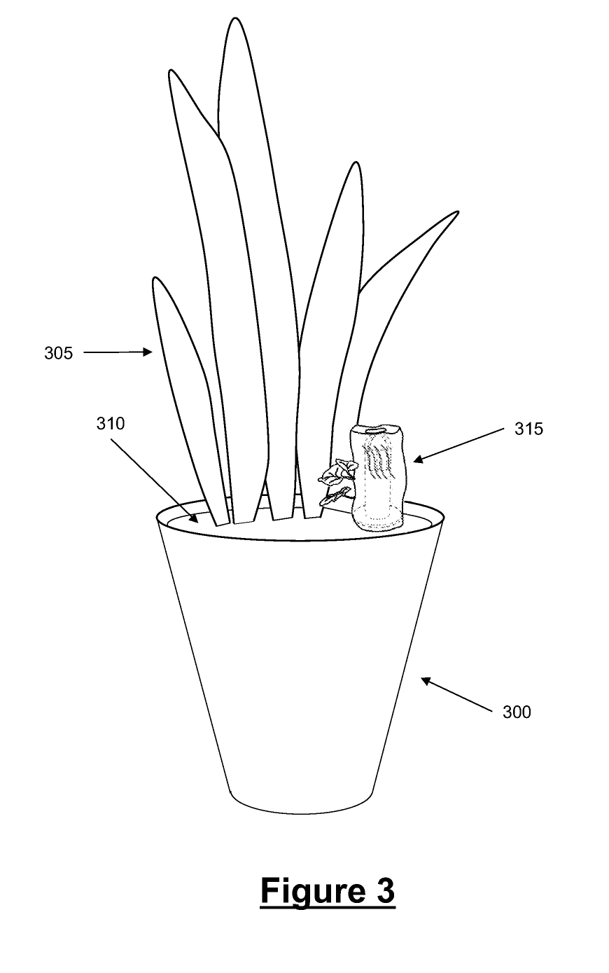

FIG. 3 illustrates the use of the present invention in plant pot 300. The plant pot 300 contains plant 305 and soil 310. The combination of the probe and natural housing 315 is inserted into the soil in the plant pot 300 down to the flange 115. In this case, the natural housing 200 is a small log with a few leaves, which hides the technology and creates the desired sense of a natural presentation. A person of ordinary skill in the art would recognize that other natural manifestations, such as a flower, a rock, or a small animal may also be used for the natural housing. In fact, a mix of such natural housing would further add to creating the impression of a natural setting, hiding the technological components.

In the preferred embodiment, the plant grower chooses a combination of the natural designs, and place multiple probes and housings close to different plants, without disturbing the natural appearance of the plants with technological components. The probe 105 monitors the current environmental conditions via the plurality of environmental sensors 125, and this information is used to provide advice to the plant grower for one or more plants close to the probe 105. Further, the plant grower can choose to move the probe and the natural housing 315 at will, relocate to a preferred location, or move to a different plant pot.

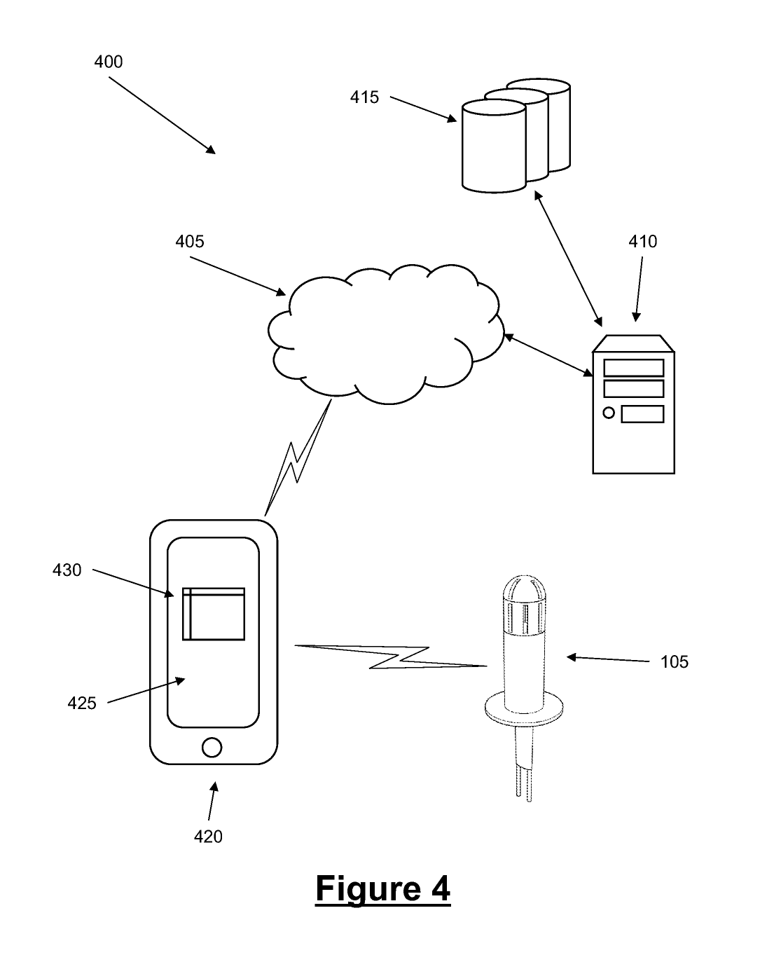

FIG. 4 illustrates the plant growth advisor system 400, which is a connected architecture consisting of a network 405, a remote computer 410, a plant profile database 415, a mobile device 420 with a mobile app 425, a plant profile 430, and the probe 105. The remote computer 410 is connected to the plant profile database 415. The remote computer 410 is connected to mobile device 420 via the network 405. The network 405 is preferably the Internet. The mobile device 420 is preferably connected to the network 405 and the probe 105 wirelessly.

The remote computer 410 is responsible for the back-end functions, such as providing security, enabling the mobile app 425 to pair with a probe 105, access plant profile database 415, register a new user, register the mobile device 420, and register the probe 105.

The plant profile database 415 is a database of optimal plant growing conditions with parameters matching the corresponding information captured by the plurality of the environmental sensors 125 in the probe 105. For example, if the probe 105 captures brightness, humidity, soil moistures, and soil pH, then so does the plant profile database 415. The plant profile database 415 optionally has additional information about each plant, such as photographs, recommended fertilizer types, the best planting dates, and other factors to help a plant grower optimize the growth of plants.

The mobile device 420 is any device such as a smartphone, a tablet, or a custom device that can be easily carried by a plant grower. The mobile app 425 is any software or firmware application that resides on the mobile device 420 to process the required information and advice for the plant grower.

Each probe 105 has a unique designation that individually identifies the probe to the plant growth advisor system 400 and its components. Thus, a probe 105 is paired with the mobile app 425 to monitor one or more plants in the vicinity of the probe 105. Further, the mobile app 425 comprehends that a probe 105 can be paired with multiple plants, each requiring a different advice.

The mobile app 425 cross references the selected plant monitored by the probe 105 with the plant profile database 415, and downloads the optimal growth parameters as plant profile 430, which is stored with the mobile device 420. The plant grower has the option to customize the information downloaded from plant profile database 415 to reflect personal preferences within the mobile app 425, essentially overriding the information provided by the plant profile database, when desired. The mobile app 425 subsequently compares the optimal growth parameters with the current environmental conditions reported by the probe 105. While limited deviations from optimal parameters are tolerated, the mobile app 425 provides notifications, alerts, and advice to the user when a certain plant needs attention, such as increase or decrease the ambient brightness, add water, change humidity, or add fertilizer. Further, the mobile app 425 may store the environmental data and present statistical information and graphs about the growth history of each plant.

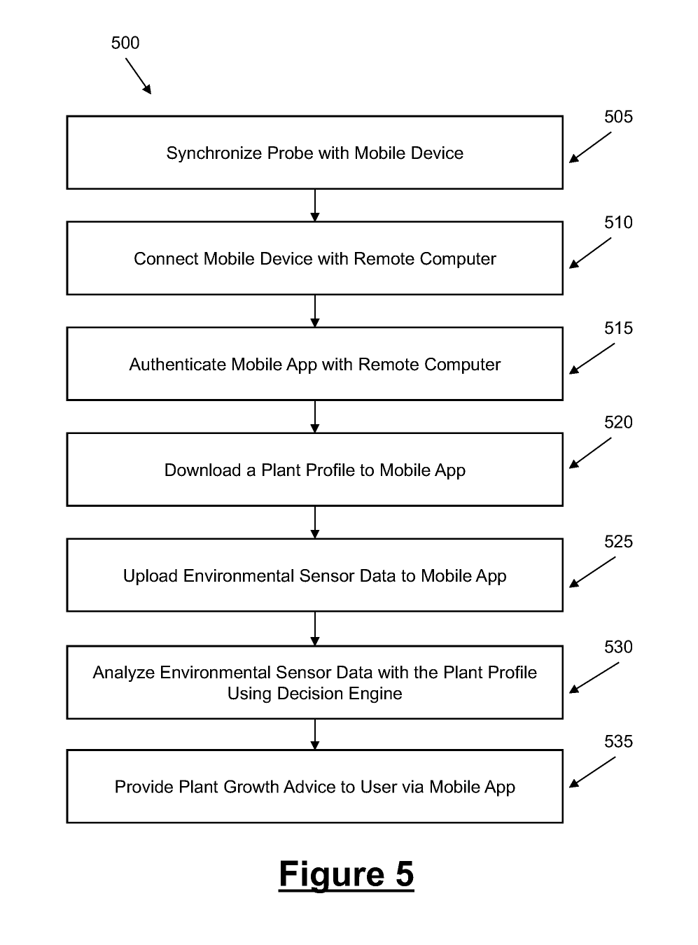

FIG. 5 illustrates the plant growth advisor process 500, which is a series of steps taken by the plant growth advisor system 400 while leveraging the plant growth advisor apparatus 100. The process begins with synchronizing the probe 105 with mobile device 505, which involves pairing a new probe 105 and a new mobile device 420 along with declaring the target plant to be grown.

The next two steps are to connect mobile device with remote computer 510 and authenticate mobile app with remote computer 515, which essentially involves placing the plant grower online with the system, and gain access to the data and services provided by the plant growth advisor system 400.

The next step is to download a plant profile to mobile app 520 corresponding to the plant intended to be grown by the plant grower. The plant profile 430 for the target plant is thus downloaded to the mobile device 420 and accessible by the mobile app 425.

Upload environmental sensor data to mobile app 525 involves the probe 105 and the plurality of the environmental sensors 125 to send the target plant's current conditions to the mobile device 425 using the communication device 135. Thus, the mobile app 425 gains access to the current conditions in the vicinity of the target plant.

Upon availability of the current environmental conditions, the analyze environmental sensor data with the plant profile using decision engine 530 step invokes a decision process comprising the comparison of the current environmental conditions with the optimal environmental factors captured in the plant profile 430. Such analysis may use any combination of information and decision processing techniques such as decision tree, inference engine, and neural nets as example. The utility of this step is to compute how the current environmental conditions of the target plant should be changed to optimize the growth of the plant.

Upon determination of the optimal conditions, the provide plant growth advice to user via mobile app 535 step essentially communicates the decision and recommendation of the system to the user. This step is accomplished via a user interface provided by them mobile app 425 on the mobile device 420, or transmitted to the probe 105 for local display.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

We claim:

1. A plant growth advisor apparatus comprising:
a natural housing, having a slit and a window;
A probe having a ground stake, and placed inside the natural housing;
a microcontroller placed inside the probe;
a plurality of environmental sensors integrated within the natural housing and the probe, and connected to the microcontroller;
a communication device placed inside the probe and connected to the microcontroller; and
a power source connected to the microcontroller, the communication device, and the environmental sensors.

2. A plant growth advisor apparatus according to claim 1, wherein the environmental sensors comprises a light sensor.

3. A plant growth advisor apparatus according to claim 2, wherein the environmental sensors comprises an air temperature sensor.

4. A plant growth advisor apparatus according to claim 3, wherein the environmental sensors comprises a air humidity sensor.

5. A plant growth advisor apparatus according to claim 4, wherein the environmental sensors comprises a soil moisture sensor.

6. A plant growth advisor apparatus according to claim 5, wherein the environmental sensors comprises a soil chemistry sensor.

7. A plant growth advisor apparatus according to claim 6, wherein the environmental sensors comprises a soil temperature sensor.

8. A plant growth advisor apparatus according to claim 7, wherein the communication device is wireless.

9. A plant growth advisor system comprising:
a probe containing a microcontroller, a plurality of environmental sensors, a communication device, a power source, a decision engine, and a plant profile;
a network;
a remote computer connected to the network;
a plant profile database connected to the remote computer;
a mobile device connected to the network and the communication device in the probe; and
a mobile app in the mobile device;

10. A plant growth advisor system according to claim 9, wherein a user interface operates in the mobile app.

11. A plant growth advisor system according to claim 10, wherein a decision engine operates in the mobile app.

12. A plant growth advisor system according to claim 11, wherein a plant alert/advice is provided by the plant growth advisor via the user interface.

13. A plant growth advisor system according to claim 12, wherein the network is wireless.

14. A plant growth advisor system according to claim 13, wherein the connection between the mobile device and the communication device is wireless.

15. A plant growth advisor system according to claim 14, wherein the decision engine is a decision tree.

16. A plant growth advisor system according to claim 14, wherein the decision engine is an expert system.

17. A plant growth advisor system according to claim 14, wherein the decision engine is a neural net.

18. A plant growth advisor process comprising:
Synchronizing a probe with a mobile device;
Connecting the mobile device with a remote computer via a network;
Authenticating a mobile app in the mobile device with the remote computer;
Downloading a plant profile from a plant profile database in the remote computer to the mobile app;
Uploading a plurality of environmental sensor data from the probe to the mobile app;
Analyzing the plurality of environmental sensor data against the plant profile using a decision engine; and
Providing a plant growth advice based on the analysis of the plurality of environmental sensor data against the plant profile.
